(19) United States
(12) Patent Application Publication
(10) Pub. No.: US 2022/0321287 A1
(43) Pub. Date: Oct. 6, 2022

(54) OVERCOMING FORWARD LINK INTERFERENCE CAUSED BY AERIAL USER EQUIPMENT

(71) Applicants: AT&T Intellectual Property I, L.P., Atlanta, GA (US); AT&T Technical Services Company, Inc., Vienna, VA (US)

(72) Inventors: Daniel Vivanco, Ashburn, VA (US); David Beppler, Duluth, GA (US); Slawomir Stawiarski, Carpentersville, IL (US)

(21) Appl. No.: 17/218,974

(22) Filed: Mar. 31, 2021

(51) Int. Cl. H04L 5/00; H04W 72/12

(52) U.S. Cl. CPC H04L 5/0032; H04W 72/1231

(57) ABSTRACT

An architecture to dynamically configure inter-cell interference coordination between terrestrial serving cell equipment that are servicing aerial user equipment. A method can comprise receiving key performance indicator value data, user equipment device type data, serving cell equipment data representing a serving cell equipment capability; based on the user equipment device type data and the serving cell equipment capability, initiating an enhanced inter-cell interference coordination process on serving cell equipment; and based on the serving cell equipment data, implementing an aggregated almost blank subframe schedule on the serving cell equipment.

### TECHNICAL FIELD

The disclosed subject matter provides systems and methods to dynamically configure inter-cell interference coordination between terrestrial fourth generation (4G), terrestrial fifth generation (5G) long term evolution (LTE), and/or other next generation terrestrial serving cell equipment that are serving aerial user equipment (UE), with the object of reducing intra-frequency interference.

### BACKGROUND

Terrestrial LTE network equipment usually use a pattern of frequencies known as frequency resuse-3 to avoid cell-edge interference, in which proximate neighboring serving cell equipment operate in different frequencies. Terrestrial based UE located at the edges of the broadcast range of serving cell equipment serving terrestrial based UE are typically not be impacted by neighboring serving cell equipment, since neighboring serving cell equipment generally operate in different frequency bands. In contrast, aerial UE placed at the same location (but at much higher altitudes above terrain) can detect signal pilots from various neighboring cell equipment that can operate in the same frequency band as a serving cell equipment, which can create large infra-frequency interferences.

Intra-frequency interference can result in low throughput, session drop, and hand over failures. Aerial UE can be severely impacted by intra-frequency interference from multiple neighboring serving cell equipment, since aerial UE typically use LTE/5G for transmitting user data as well as to receive and/or transmit flight control data, navigation data, and/or aerial UE control data.

### BRIEF DESCRIPTION OF DRAWINGS

FIG. 1 is an illustration of a system that dynamically configure inter-cell interference coordination between terrestrial based serving cell equipment that are serving aerial user equipment (UE), in accordance with aspects of the subject disclosure.

FIGS. 2 and 3 provide illustration in regard to operation of the aggregated ABS schedule that serving cell equipment can be directed to use to overcome forward link interference caused by aerial UE, in accordance with aspects of the subject disclosure.

FIG. 4 provides illustration of a flow chart or method for dynamically configuring inter-cell interference coordination between terrestrial based serving cell equipment that are serving aerial UE, in accordance with aspects of the subject disclosure.

FIG. 5 provides illustration of a time sequence chart or method for dynamically configuring inter-cell interference coordination between terrestrial based serving cell equipment that are serving aerial user UE, in accordance with aspects of the subject disclosure.

FIG. 6 provides depiction of serving cell equipment and proximate neighbor cell equipment, in accordance with aspects of the subject disclosure.

FIG. 7 provides illustration of how network equipment antenna direction affects aerial user equipment, in accordance with aspects of the subject disclosure.

FIG. 8 provides depiction of network equipment association patterns at different altitudes, in accordance with aspects of the subject disclosure.

FIG. 9 is a block diagram of an example embodiment of a mobile network platform to implement and exploit various features or aspects of the subject disclosure.

FIG. 10 illustrates a block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

The disclosed systems and methods, in accordance with various embodiments, provide a system, apparatus, equipment, or device comprising: a processor, and a memory that stores executable instructions that, when executed by the processor, facilitate performance of operations. The operations can comprise receiving, via a user equipment, key performance indicator value data and user equipment device type data; receiving, via serving cell equipment, serving cell equipment data representing a serving cell equipment capability; based on the user equipment device type data and the serving cell equipment capability, facilitating the serving cell equipment to implement an enhanced inter-cell interference coordination process; and generating, based on the serving cell equipment data, an aggregated almost blank subframe schedule for use by the serving cell equipment.

Additional operations can comprise determining, based on the user equipment type data, that the user equipment is aerial user equipment; receiving, via database equipment, network topology data associated with the serving cell equipment; when the key performance indicator value data represents signal to noise ratio data, determining that the signal to noise ratio data is less than a threshold value.

Further operations can comprise when the serving cell equipment is associated with a first physical cell identity value, facilitating the user equipment to return a report comprising a group of neighbor cell equipment with a second physical cell identity value that match the first physical cell identity value; when the key performance indicator values are first key performance indicator values, facilitating the user equipment to return second key performance indication values represent a receive signal to receive power value; when the serving cell equipment operates using a first frequency band, generating a listing of neighboring serving cell equipment that operate in the first frequency band; determining, based on the listing of neighboring serving cell equipment, a collection of neighboring serving cell equipment capable of initiating the enhanced inter-cell interference coordination process; indicating that the collection of neighboring serving cell equipment are aggressor serving cell equipment; and based on an absence the serving cell equipment being included in the collection of neighboring serving cell equipment indicating that the serving cell equipment is a victim serving cell equipment.

In accordance with further embodiments, the subject disclosure describes a method and/or process, comprising a series of acts that, for example, can include: receiving, by network equipment comprising a processor, key performance indicator value data, user equipment device type data, serving cell equipment data representing a serving cell equipment capability; based on the user equipment device type data and the serving cell equipment capability, initiating, by the network equipment, an enhanced inter-cell interference coordination process on serving cell equipment; and based on the serving cell equipment data, generating, by the network equipment, an aggregated almost blank subframe schedule for use by the serving cell equipment.

Additional acts can comprise based on the user equipment type data, determining, by the network equipment, that the user equipment is aerial user equipment; receiving, by the network equipment, network topology data associated with the serving cell equipment; when the key performance indicator value data represents signal to noise ratio data, and determining, by the network equipment, that the signal to noise ratio data is less than a threshold value; and when the serving cell equipment is associated with a first physical cell identity value, obtaining, by the network equipment, a report comprising a group of neighbor cell equipment with a second physical cell identity value that match the first physical cell identity value.

In accordance with still further embodiments, the subject disclosure describes a machine readable medium, a computer readable storage device, or non-transitory machine readable media comprising instructions that, in response to execution, cause a computing system (e.g., equipment, devices, groupings of devices, etc.) comprising at least one processor to perform operations. The operations can include: receiving key performance indicator value data, user equipment device type data, serving cell equipment data representing a serving cell equipment capability; based on the user equipment device type data and the serving cell equipment capability, initiating an enhanced inter-cell interference coordination process on serving cell equipment; and based on the serving cell equipment data, implementing an aggregated almost blank subframe schedule on the serving cell equipment.

Further operations can include: in instances when the key performance indicator value data represents signal to noise ratio data, determining that the signal to noise ratio data is less than a threshold value; in instances when the serving cell equipment is associated with a first physical cell identity value, receiving a report comprising a group of neighbor cell equipment with a second physical cell identity value that match the first physical cell identity value; in instances when the key performance indicator values are first key performance indicator values, facilitating the user equipment to return second key performance indication values representing a receive signal to receive power value; and when the serving cell equipment operates using a first frequency band, generating a listing of neighboring serving cell equipment that operate in the first frequency band.

Additional operations can comprise, when the serving cell equipment operates using a first frequency band, generating a listing of neighboring cell equipment that operate in the first frequency band representing a group of aggressor cell equipment, wherein the key performance value data is first key performance value data, and wherein the group of aggressor cell equipment is associated with respective second key performance value data. Further operations can comprise mandating initiation of an enhanced inter-cell interference coordination process on the serving cell equipment and the group of aggressor cell equipment, wherein initiation of the enhanced inter-cell interference coordination process comprises using coordinated subframe data and power scheduling data associated respectively with serving cell equipment and the group of aggressor cell equipment, and wherein the initiation of the enhanced inter-cell interference coordination process reduces and eliminates intra-frequency interference, and wherein the initiation of the enhanced inter-cell interference coordination process eliminates the intra-frequency interference induced by the group of aggressor cell equipment to aerial user equipment, wherein the aerial user equipment is being served by the serving cell equipment.

The subject disclosure, in various embodiments, describes systems and methods to dynamically configure inter-cell interference coordination between terrestrial based serving cell equipment that are serving aerial UE. As has been noted above, aerial UE can receive significant intra-frequency interference from neighboring serving cell equipment (e.g., neighboring cell equipment situated proximate to current serving cell equipment). Infra-frequency interference in the context of aerial UE can result in low throughput, session drop, and handover failures, which can impact the facilities and functionalities of aerial UE.

In the context of the subject disclosure, network equipment and/or serving cell equipment is typically base station equipment, eNodeB equipment, eNB equipment, gNodeB equipment, picocell equipment, macrocell equipment, microcell equipment, femtocell equipment, IoT equipment operating as mobile network operation (MNO) network equipment, access point equipment, or other such equipment. Further, the disclosed systems and/or methods can be operational at central node global control equipment located in the core network. Examples of central node global control equipment can be mobile edge computing (MEC) equipment, self organized network (SON) equipment, and/or radio access network intelligent controller (RIC) equipment.

The described systems and/or methods, in some embodiments, can collect UE information data and/or UE device type data. The systems and/or methods, in various embodiments, can detect when, where, and whether an aerial UE is attached to and/or is in operative communication with the core network (or identifiable segments of the core network). Additionally, the described systems and/or methods, in accordance with further embodiments can collect data representative of serving cell equipment capabilities, as well as network topologies of serving cell equipment (e.g., the network topologies of serving cell equipment currently providing service to aerial UE and/or terrestrial based UE situated within the broadcast range of current cell equipment and neighboring serving cell equipment that can be immediately proximate to, or positioned at distance from, current serving cell equipment). The disclosed systems and/or methods, in accordance with various other embodiments, can also collect data representative of the geographical topographies and/or locations within which current serving cell equipment and its neighboring serving cell equipment are situated.

The described systems and/or methods, in accordance with some embodiments, based at least in part on data representative of UE information and UE device type, can determine whether or not a UE is an aerial UE. Information in regard to whether or not UE is an aerial type UE or terrestrial based UE can be conveyed and communicated to central node global control equipment as a flag comprising one or more bits. The central node global control equipment can then utilize and/or consult, for example, one or more database equipment comprising groups of relevant database tuples to correlate the received bits with an UE type (e.g., aerial UE or terrestrial based UE).

Additionally, central node global control equipment, based at least in part on data representative of serving cell equipment capabilities, network topologies of serving cell equipment, and the geographical topographies and/or locations within which serving cell equipment are situated, can determine whether serving cell equipment support enhanced inter-cell interference coordination (EICIC).

EICIC deals with inter-cell interference issues. EICIC features increases to the coverage areas of “victim” serving cell equipment without boosting downlink (DL) power. EICIC can be used between serving cell equipment that operate in the same frequency band and have overlapping broadcast or transmission umbrae and/or penumbrae. Both serving cell equipment: victim serving cell equipment and “aggressor” serving cell equipment can coordinate DL transmit scheduling in defined time domains in order to facilitate inter-cell interference. Aggressor serving cell equipment is typically equipment with higher transmit power compared with victim serving cell equipment. Further, aggressor serving cell equipment and victim serving cell equipment are generally proximate to one another. UE in communication with victim serving cell equipment can receive interference from aggressor serving cell equipment, for instance, at the edge of the transmit coverage provided by the victim serving cell equipment.

Time domain inter-cell interference coordination can be realized by using almost blank subframes (ABS). ABSs are typically subframes (SFs) with reduced transmit power on groups of identified or identifiable physical channels and/or and associated with reduced activity. ABS generally do not carry any data (e.g., physical downlink shared channel (PDSCH)—the main data bearing channel which is allocated to users on a dynamic and opportunistic basis) and thus no corresponding control information, such as physical downlink control channel (PDCCH) used to carry downlink control information (DCI) including downlink scheduling assignments and uplink scheduling grants; enhanced physical downlink control channel (EPDCCH)—channels used to inform UE about the scheduling and resource allocation; physical control format indicator channel (PCFICH)—used at the start of subframes and provides information about the number of symbols used for PDCCH transmissions (the signaling values for PCFICH can depend upon channel bandwidths); and physical hybrid ARQ indicator channel—channels used to carry positive or negative acknowledgements (ACK/NACK) for uplink data transferred on the physical uplink shared channel (PUSCH)). Nevertheless, control signal data can be transmitted in ABS. ABS can comprise necessary signal data with low power. This signal data can comprise cell reference signal (CRS) data, synchronization signal data (e.g., primary synchronization signal (PSS) data and/or secondary synchronization signal (SSS) data), broadcast data (e.g., system information block type 1 (SIB1) data that can communicate cell access related information to UE), and paging message data.

Aggressor serving cell equipment will typically transmit ABS to protect resources and subframes in victim serving cell equipment receiving stronger inter-cell interference. For example, if victim serving cell equipment schedules its associated UE in subframes that overlap with an aggressor serving cell equipment's ABS, the victim serving cell equipment “protects” UE for which it is responsible from the stronger inter-cell interference.

Aggressor serving cell equipment will generally transmit ABS according to a semi-static pattern. During these subframes, UE at serving cell equipment cell edges (e.g., at the peripheral extent of a serving cell equipment's transmission/broadcast range) can receive downlink information, both control and/or user data from victim serving cell equipment. Note that the UE at a victim serving cell equipment central region (e.g., not at the cell edge) can still receive data in all the subframes regardless of whether or not aggressor serving cell equipment is transmitting ABS, as the interference is not that significant.

The aggressor serving cell equipment will typically inform victim serving cell equipment about the ABS via X2 application protocol messaging (e.g., X2AP LOAD INFORMATION message). The information element (IE) ABS information included in the X2AP LOAD INFORMATION message data can comprise ABS pattern data IE and information about which subframes the serving cell equipment (e.g., macro eNB) is configuring as ABS. Victim serving cell equipment can take such information into consideration when scheduling its UE. The pattern can repeat for a defined number of subframes (e.g., 40 subframes) in the case of frequency division duplex (FDD) spectrum use, whereas for time division duplex (TDD) spectrum usage periodicity can be determined based on the uplink/downlink (UL/DL) configurations.

In instances where serving cell equipment supports EICIC, central node global control equipment can collect key performance indicator (KPI) values returned to, or received by, serving cell equipment (or central node global control equipment) by UE (terrestrial based and/or aerial) located within the coverage ambit of serving cell equipment. Examples of KPI values that can be returned by UE to serving cell equipment can include: values associated with RSRP measurement values, received signal strength indicator (RSSI) measurement values, quality of service (QoS) metric values, signal to noise ratio (SNR) values, received signal code power (RSCP) values, signal to interference ratio (SIR) values, signal to interference plus noise ratio (SINR) values, distance measurement values (e.g., determined based on global positioning satellite (GPS) data, geo-location data, geo-tag data, or other such relevant positioning data) indicating distances between UE and serving cell equipment, distance measurement values indicating distances between UE and respective neighboring serving cell equipment, or other similarly appropriate values. As has been noted, KPI values can be values that can have been periodically returned within measurement reports by UE extant with the control and/or coverage ambit associated with network equipment, such as serving cell equipment, neighboring serving cell equipment, or similar network equipment.

In accordance with various embodiments, central node global control equipment can use RSRP value data and SNR value data received from aerial UE to generate a ranked and/or ordered listing of serving cell equipment and determine whether SNR value data is low. Central node global control equipment can determine whether or not SNR value data is low, for example, by comparing received SNR value data with one or more defined or definable threshold values. In instances where it is determined that SNR value data is low, the central node global control equipment can request UE to scan and report back data pertaining to neighboring serving cell equipment with corresponding physical cell identity (PCI) values and scanned signal strength (e.g., RSRP) values.

Central node global control equipment can then filter from the organized and/or ranked of listing neighboring serving cell equipment serving cell equipment that: operate in the same frequency band, and/or are operational in the vicinity of serving cell equipment that is currently serving aerial UE. Neighboring serving cell equipment that are determined to both operate in the same frequency band, and that are operational within a defined or definable vicinity of serving cell equipment that is currently serving aerial UE can be placed in a list of identified neighboring serving cell equipment.

Central node global control equipment can thereafter direct serving cell equipment and/or serving cell equipment identified in the list of identified neighboring serving cell equipment to engage into EICIC. Central node global control equipment can consider serving cell equipment included in the list of identified neighboring serving cell equipment as being aggressor serving cell equipment and the serving cell equipment as being the victim serving cell equipment (e.g., victim serving cell equipment will typically be serving cell equipment excluded from the list of identified neighboring serving cell equipment).

Central node global control equipment can then generate an aggregated ABS schedule that serving cell equipment included in the list of identified neighboring serving cell equipment can use in order to overcome forward link interference induced to aerial UE with the objective of reducing intra-frequency interference. The aggregated ABS schedule reduces and/or eliminates overall interference caused by aerial UE to serving cell equipment included in the list of identified neighboring serving cell equipment. The aggregated ABS schedule in some embodiments can be generated based on determined interference that each serving cell equipment included in the list of identified neighboring serving cell equipment is injecting into aerial UE and/or UE demand requirements.

Many use cases of unmanned aerial vehicles (UAVs), such as drones, require beyond visual line of sight (LOS) communications. Mobile networks can offer wide area, high speed, and secure wireless connectivity, which can enhance control and safety of UAV operations and enable beyond visual LOS use cases. Existing long term evolution (LTE) networks can support initial drone deployments. LTE evolution and 5G can provide more efficient connectivity for wide-scale drone deployments. New and exciting applications for drones are being envisioned and are emerging. These envisioned and prospective applications can be a potential boon for mobile network operator entities. Use cases of commercial UAVs are growing rapidly, including delivery, communications and media, inspection of critical infrastructure, surveillance, search-and-rescue operations, agriculture, and similar worthy endeavors.

Research and development of current mobile broadband communication (e.g., LTE) has been primarily devoted to terrestrial based communication. Providing tether-less broadband connectivity for UAVs is an emerging field.

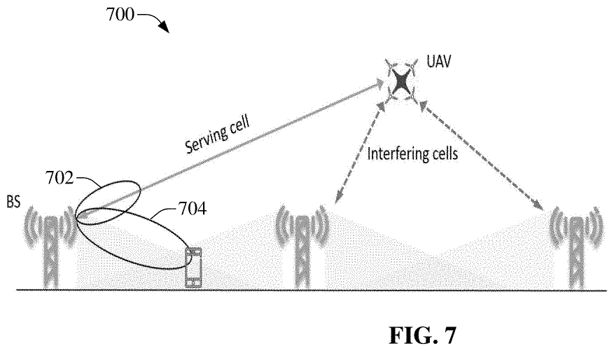

One main aspect that makes using LTE to serve UAVs challenging is the fact that mobile LTE networks are generally optimized for terrestrial broadband communication. Thus, the antennas associated with terrestrial based serving equipment (such as base station equipment, eNodeB equipment, eNB equipment, gNodeB equipment, picocell equipment, macrocell equipment, microcell equipment, femtocell equipment, IoT equipment operating as mobile network operation (MNO) network equipment, access point equipment, and the like) are typically down-tilted to reduce the interference power levels to other serving cell equipment. With down tilted antennas, small UAVs may thus only be served by transmission or broadcast side lobes of the antennas associated with terrestrial based serving cell equipment. FIG. 7 illustrates the broadcast disparity between the down-tilted antennas 702 and side lobes 704.

Due to the presence of possible voids or nulls in the transmission side lobes 704, and due to close-to-free-space propagation in the sky, aerial UAVs or aerial UEs can detect several ground-based serving cell equipment within a defined geographical area. In addition, aerial UE, since they typically are positioned above terrestrial based radio equipment and above radio signal echo (e.g., radio clutter) emanating from serving cell equipment, can detect stronger signals from distant serving cell equipment (e.g., interfering cells) than terrestrial based UE that are more geographically proximate. Thus, aerial UE can be served by much more distant serving cell equipment (e.g., interfering cells) instead of the most proximate serving cell equipment.

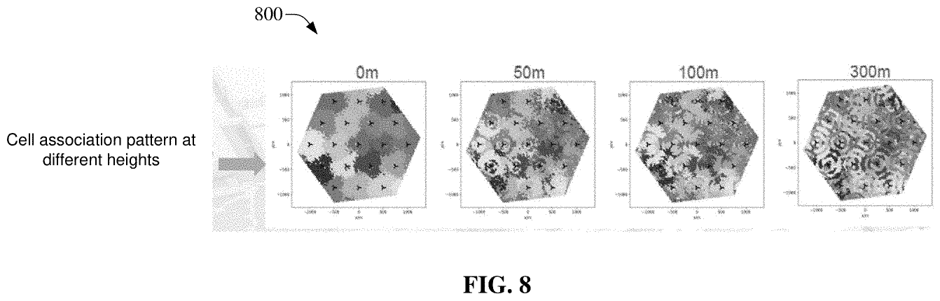

FIG. 8 provides depiction of the relative disparities in coverage areas between terrestrial coverage areas and aerial coverage areas. In FIG. 8 it will be observed, that at lesser heights, for example, at 0 meters (m) the broadcast coverage area pattern of network cell equipment is generally distinct and clear; the coverage areas being defined clusters around one or more central point associated with respective network cell equipment. However, at greater heights (e.g., 50 m, 100 m, 300 m) above terrain the coverage areas associated with respective network equipment become less and less well defined and more and more amorphous.

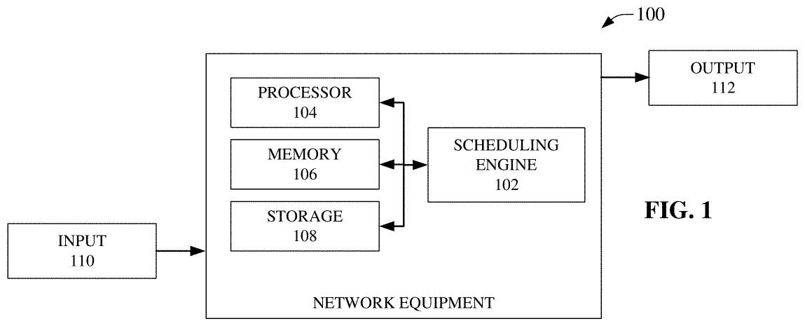

With reference to the Figures, FIG. 1 illustrates a system 100 (e.g., network equipment) that dynamically configures inter-cell interference coordination between terrestrial based serving cell equipment that are serving aerial UE with the object of reducing and/or eliminating the overall interference caused by aerial UE. System 100 can be central node global control equipment located on the core network. Examples of central node global control equipment can be MEC equipment, SON equipment, and/or RIC equipment.

As illustrated system 100 can comprise scheduling engine 102 that can be communicatively coupled to processor 104, memory 106, and storage 108. Scheduling engine 102 can be in communication with processor 104 for facilitating operation of computer and/or machine executable instructions and/or components by scheduling engine 102, memory 106 for storing data and/or the computer or machine executable instructions and/or components, and storage 108 for providing longer term storage for data and/or machine and/or computer machining instructions. Additionally, system 100 can receive input 110 for use, manipulation, and/or transformation by scheduling engine 102 to produce one or more useful, concrete, and tangible result, and/or transform one or more articles to different states or things. Further, system 100 can also generate and output the useful, concrete, and tangible results, and/or the transformed one or more articles produced by scheduling engine 102, as output 112.

In some embodiments, system 100 can be Internet of Things (IoT) small form factor equipment capable of effective and/or operative communication with a network topology. Additionally in alternative embodiments, system 100 can be any type of mechanism, machine, device, apparatus, equipment, and/or instrument that can be utilized to dynamically configure inter-cell interference coordination between terrestrial based serving cell equipment that are serving aerial UE. Examples of types of mechanisms, equipment, machines, devices, apparatuses, and/instruments can include virtual reality (VR) devices, wearable devices, heads up display (HUD) devices, machine type communication devices, and/or wireless devices that communicate with radio network nodes in a cellular or mobile communication system. In various other embodiments, system 100 can comprise tablet computing devices, handheld devices, server class computing machines and/or databases, laptop computers, notebook computers, desktop computers, cell phones, smart phones, commercial and/or consumer appliances and/or instrumentation, industrial devices and/or components, personal digital assistants, multimedia Internet enabled phones, Internet enabled devices, multimedia players, aeronautical/avionic devices associated with, for example, orbiting satellites and/or associated aeronautical vehicles, and the like.

Scheduling engine 102 can collect UE information data and/or UE device type data. In various embodiments, scheduling engine 102 can detect when, where, and whether an aerial UE is attached to and/or is in operative communication with the core network (or identifiable segments of the core network). Additionally, scheduling engine 102, in accordance with further embodiments can collect data representative of serving cell equipment capabilities, as well as network topologies of serving cell equipment (e.g., the network topologies of serving cell equipment currently providing service to aerial UE and/or terrestrial based UE situated within the broadcast range of current cell equipment and neighboring serving cell equipment that can be immediately proximate to, or positioned at distance from, current serving cell equipment). Scheduling engine 102, in accordance with various other embodiments, can also collect data representative of the geographical topographies and/or locations within which current serving cell equipment and its neighboring serving cell equipment are situated.

Scheduling engine 102, as a function of data representative of UE information and UE device type, can determine whether or not a UE is an aerial UE. Information in regard to whether or not UE is an aerial type UE or terrestrial based UE can be conveyed and communicated to central node global control equipment (e.g. scheduling engine 102) as flag data comprising one or more bits. Scheduling engine 102 can then utilize and/or consult, for example, one or more database equipment comprising groups of relevant database tuples to correlate the received flag data with an UE type (e.g., aerial UE or terrestrial based UE).

Scheduling engine 102 as a function of data representative of serving cell equipment capabilities, network topologies of serving cell equipment, and the geographical topographies and/or locations within which serving cell equipment are situated, can determine whether serving cell equipment support EICIC.

In instances where serving cell equipment supports EICIC scheduling engine 102 can collect KPI values returned to, or received by, serving cell equipment (or central node global control equipment) by UE (terrestrial based and/or aerial) located within the coverage ambit of serving cell equipment. Illustrative KPI values that can be returned by UE to serving cell equipment can include: values associated with RSRP measurement values, RSSI measurement values, QoS metric values, SNR values, RSCP values, SIR values, SINR values, distance measurement values (e.g., determined based on GPS data, geo-location data, geo-tag data, or other such relevant positioning data) indicating distances between UE and serving cell equipment, distance measurement values indicating distances between UE and respective neighboring serving cell equipment, or other similarly appropriate values. As has been noted, KPI values can be values that can have been periodically returned within measurement reports by UE extant with the control and/or coverage ambit associated with network equipment, such as serving cell equipment, neighboring serving cell equipment, or similar network equipment.

Scheduling engine 102, in some embodiments, can use RSRP value data and SNR value data received from aerial UE to generate a ranked and/or ordered listing of serving cell equipment and determine whether SNR value data is low. Scheduling engine 102 can determine whether or not SNR value data is low, for example, by comparing received SNR value data with one or more defined or definable threshold values. In instances where it is determined that SNR value data is low, scheduling engine 102 can request UE to scan and report back data pertaining to neighboring serving cell equipment with corresponding PCI values and scanned signal strength (e.g., RSRP) values.

Scheduling engine 102 can then filter from the organized an/or ranked of listing neighboring serving cell equipment serving cell equipment that: operate in the same frequency band, and/or are operational in the vicinity of serving cell equipment that is currently serving aerial UE. Neighboring serving cell equipment that are determined to both operate in the same frequency band, and that are operational within a defined or definable vicinity of serving cell equipment that is currently serving aerial UE can be placed in a list of identified neighboring serving cell equipment.

Scheduling engine 102 can thereafter direct serving cell equipment and/or serving cell equipment identified in the list of identified neighboring serving cell equipment to engage into EICIC. Scheduling engine 102 can consider serving cell equipment included in the list of identified neighboring serving cell equipment as being aggressor serving cell equipment and the serving cell equipment as being the victim serving cell equipment (e.g., victim serving cell equipment will typically be serving cell equipment excluded from the list of identified neighboring serving cell equipment).

Scheduling engine 102 can then generate an aggregated ABS schedule that serving cell equipment included in the list of identified neighboring serving cell equipment can use in order to overcome forward link interference caused by aerial UE with the object of reducing intra-frequency interference. The aggregated ABS schedule reduces and/or eliminates overall interference caused by aerial UE to serving cell equipment included in the list of identified neighboring serving cell equipment. The aggregated ABS schedule in some embodiments can be generated based on determined interference that each serving cell equipment included in the list of identified neighboring serving cell equipment is injecting into aerial UE and/or UE demand requirements.

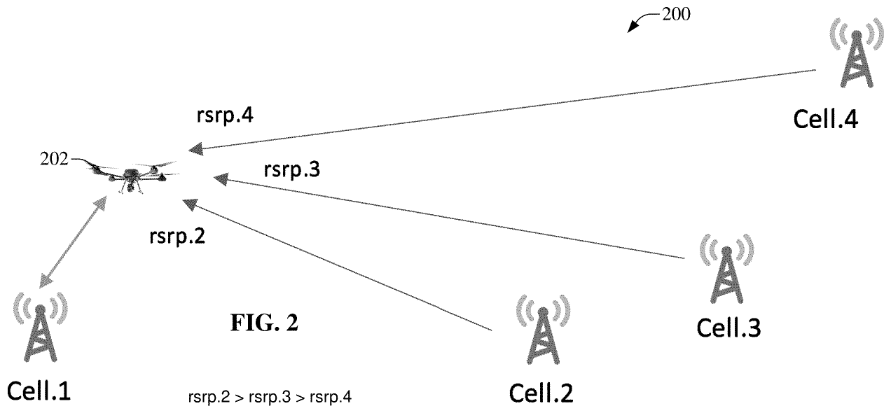

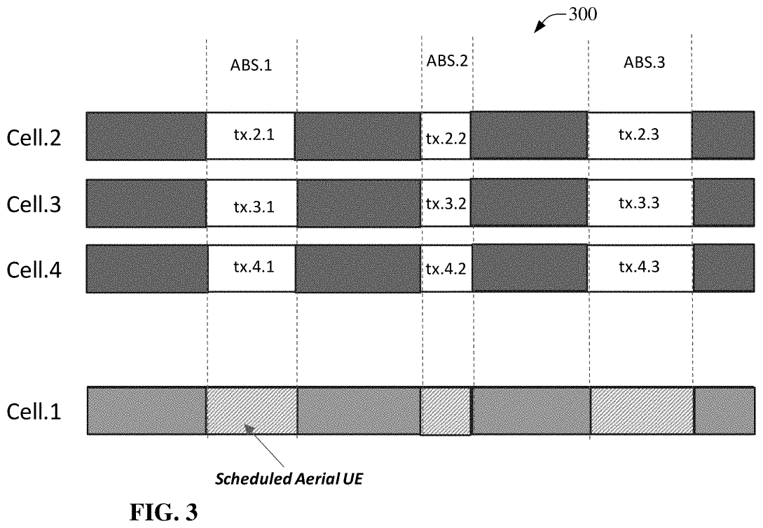

FIGS. 2 and 3 provide an illustration in regard to operation of the aggregated ABS schedule that serving cell equipment can be directed to use to overcome forward link interference caused by aerial UE with the object of reducing intra-frequency interference. As depicted in FIG. 2 an aerial device 202 can be attached and/or in operative communication with serving cell equipment (e.g., cell.1). Cell.1 can operate in a first frequency band. Neighboring serving cell equipment (e.g., cell.2, cell.3, and cell.4) can also be operating in the first frequency band and can be injecting downlink (DL) interference into aerial UE. Other UE (e.g., terrestrial based UE) attached to and/or in communication with cell.1 will typically not experience the DL interference to which aerial UE is being subjected to. In this instance, serving cell equipment (e.g., cell.1) and its neighboring serving cell equipment (e.g., cell.2, cell.3, and cell.4) can each be capable of engaging in EICIC, and as such central node global control equipment (e.g., scheduling engine 102) can mandate that all the serving cell equipment (e.g., cell.1, cell.2, cell.3, and cell.4) engage in EICIC.

With reference to FIG. 3 scheduling engine 102 can schedule the duration of a first ABS (e.g., ABS.1) during the first ABS subframe traffic transmitted by neighboring cell equipment (e.g., cell.2, cell.3, and/or cell.4) at reduced power. For example, cell.2 can transmit at a first reduced power tx.2.1, cell.3 can transmit a second reduced power tx.3.1, cell.4 can transmit a third reduced tx.4.1. Scheduling engine 102 can determine both the duration of the ABSs (e.g., ABS.1, ABS.2, ABS.3, . . . ), as well as, the respective reductions in power (e.g., the first reduced power, the second reduced power, the third reduced). The durations of the ABSs and the respective reductions in power can be based, for example, on aerial UE demand and aerial UE requirements, respective serving cell equipment (e.g., serving cell equipment (cell.1) and its neighboring serving cell equipment (e.g., cell.2, cell.3, and/or cell.4)) utilization, KPI values (e.g., signal strength values (such as RSRP values) that can have been received from UE attached and/or in communication with respective neighboring serving cell equipment (e.g., cell.2, cell.3, and/or cell.4). It will be noted in the context of FIG. 2 that the transmission power of the neighboring serving cell equipment (e.g. cell. 2) has to be reduced more than the transmit power of neighboring serving cell equipment (e.g., cell. 3 and cell.4) since the signal strength values returned by UE respectively in communication with each of the neighboring serving cell equipment (e.g., cell.2, cell.3, and/or cell.4), at this particular time instance, have been ranked or ordered as: rsrp.2>rsrp.3>rsrp.4).

Scheduling engine 102 can constantly, and/or periodically at defined or determinable time intervals, request, or facilitate, UE to report SNR values back to central node global control equipment. In instances when SNR values fall below defined or definable threshold values, scheduling engine 102 can direct neighboring cell equipment (e.g., cell.2, cell.3, and/or cell.4) to reduce their transmission power in subsequent ABS subframes to even lower power levels than the transmission power used in reference to the initial ABS (e.g., ABS.1) subframe.

Scheduling engine 102 can determine the duration for the initial ABS (e.g., ABS.1) as a function of the amount of scheduled traffic emanating from the serving cell equipment (e.g., cell.1) to aerial UE associated with the serving cell equipment (e.g., cell.1). In this context, large amounts of traffic between aerial UE and the serving cell equipment can require large ABS (e.g., ABS.1) durations.

In regard to FIGS. 2 and 3 and in the context of various embodiments, scheduling engine 102 can schedule a second ABS (e.g., ABS.2) and can reduce the respective transmit power of each of the neighboring serving cell equipment to be tx.2.2, tx.3.2, and tx.4.2. It should be noted that in some instances, scheduling engine 102 may not reduce the respective transmit power for each of the neighboring serving cell equipment when scheduling the second ABS, determining that the respective matrix of transmit powers determined and utilized in regard to the first/initial ABS was beneficial and/or satisfactory. Nonetheless, scheduling engine 102 can dynamically recalculate ABS duration and corresponding reductions in transmit power for neighboring cell equipment while aerial UE is airborne and/or while aerial UE is traversing through airspace over which serving cell equipment (e.g., serving cell equipment and/or its neighboring serving cell equipment) has control and has been tasked with managing and/or monitoring.

In regard to FIGS. 2 and 3 and in the context of additional and/or alternative embodiments, while aerial UE is airborne and/or is moving through air space over which serving cell equipment and serving cell equipment's neighboring serving cell equipment have management and/or control, it is possible that the respective transmission power of neighboring serving cell equipment can fluctuate, in some instances, the transmission power of certain neighboring serving cell equipment can become stronger while the transmission power of certain other neighboring serving cell equipment can become weaker. In these instances, respective transmission powers tx.2.2, tx.3.2, and tx.4.2, can be recalculated by scheduling engine 102.

With respect to FIGS. 2 and 3 and in the context of further additional and/or alternative embodiments, during the time instance of an ABS subframe a first neighboring serving cell equipment (e.g., cell.2), a second neighboring serving cell equipment (e.g., cell.3), and/or a third neighboring serving cell equipment (e.g., cell.4) can have limited DL transmissions to their respective UE. Generally, in these instances large ABS durations and/or multiple ABS subframes can impact the performance of terrestrial based UE respectively associated with these neighboring serving cell equipment. In order to mitigate these deleterious performance impacts to terrestrial based UE, scheduling engine 102 can take these considerations into account when scheduling ABS subframes.

Once again with regard to FIGS. 2 and 3 and in the context of additional embodiments, scheduling engine 102 can use one or more analytic engines to study past traffic patterns in order to predict future traffic patterns and associated traffic DL UE demands. The prediction of future traffic patterns and associated traffic DL UE demand over defined or determinable time horizons can be used to forecast ABS durations and/or reductions in transmission powers.

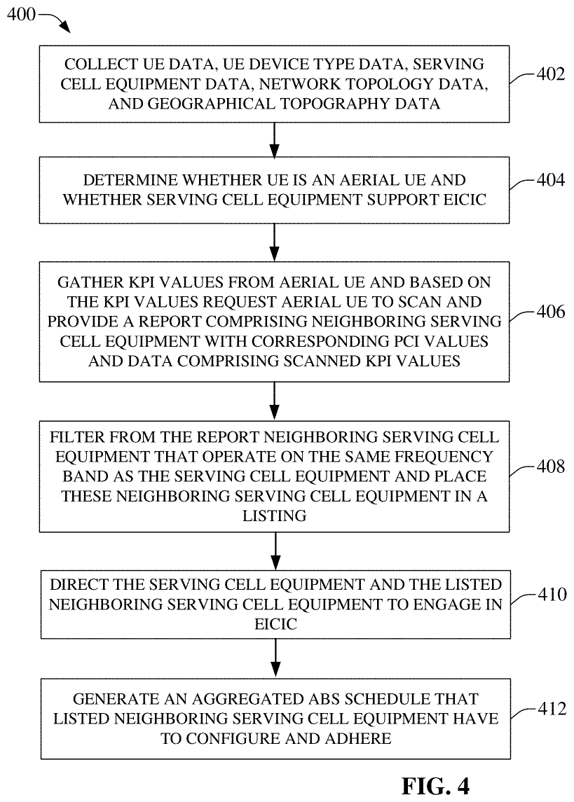

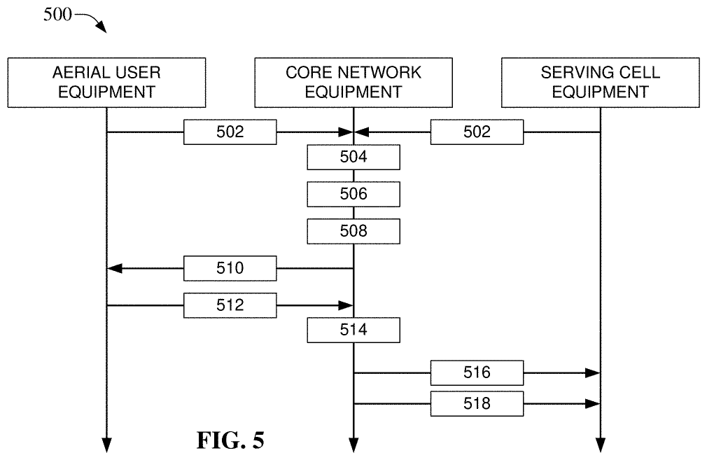

In view of the example system(s) described above, example method(s) that can be implemented in accordance with the disclosed subject matter can be better appreciated with reference to the flowcharts and/or illustrative time sequence charts in FIGS. 4-5. For purposes of simplicity of explanation, example method disclosed herein is presented and described as a series of acts; however, it is to be understood and appreciated that the disclosure is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, the disclosed example method can be implemented in combination with one or more other methods, to accomplish one or more aspects herein described. It should be further appreciated that the example method disclosed throughout the subject specification are capable of being stored on an article of manufacture (e.g., a computer-readable medium) to allow transporting and transferring such methods to computers for execution, and thus implementation, by a processor or for storage in a memory.

FIG. 4 illustrates a flow chart or method 400 that can be used to dynamically configure inter-cell interference coordination between terrestrial based serving cell equipment that are serving aerial UE with the aim of reducing and/or eliminating the overall interference caused by aerial UE. Method 400 can be used by central node global control equipment located on the core network. Examples of central node global control equipment can be MEC equipment, SON equipment, and/or RIC equipment.

Method 400 can commence at act 402 wherein central node global control equipment (e.g., scheduling engine 102) can collect UE data, UE device type data, serving cell equipment data, network topology data, and/or geographical topographic data. At act 402, in some embodiments, scheduling engine 102 can detect when, where, and whether an aerial UE is attached to and/or is in operative communication with the core network (or identifiable segments of the core network). Additionally, at act 402, scheduling engine 102 can collect data representative of serving cell equipment capabilities, as well as network topologies of serving cell equipment. Further at act 402 scheduling engine 102 can also collect data representative of the geographical topographies and/or locations within which current serving cell equipment and its neighboring serving cell equipment are situated.

At act 404 scheduling engine 102, as a function of data representative of UE information and UE device type, can determine whether or not a UE is an aerial UE. Information in regard to whether or not UE is an aerial type UE or terrestrial based UE can be conveyed and communicated to central node global control equipment (e.g. scheduling engine 102) as flag data comprising one or more bits. Also at act 404, scheduling engine 102 can utilize and/or consult, for example, one or more database equipment comprising groups of relevant database tuples to correlate the received flag data with an UE type (e.g., aerial UE or terrestrial based UE).

Additionally at act 404, scheduling engine 102, as a function of data representative of serving cell equipment capabilities, network topologies of serving cell equipment, and the geographical topographies and/or locations within which serving cell equipment are situated, can determine whether serving cell equipment support EICIC.

At act 406, in instances where serving cell equipment supports EICIC, scheduling engine 102 can collect KPI values returned to, or received by, serving cell equipment (or central node global control equipment) by UE (terrestrial based and/or aerial) located within the coverage ambit of serving cell equipment.

Also at act 406, scheduling engine 102, in some embodiments, can use RSRP value data and SNR value data received from aerial UE to generate a ranked and/or ordered listing of serving cell equipment and determine whether SNR value data is low. Scheduling engine 102 can determine whether or not SNR value data is low, for example, by comparing received SNR value data with one or more defined or definable threshold values. At act 406, in instances where it is determined that SNR value data is low, scheduling engine 102 can request UE to scan and report back data pertaining to neighboring serving cell equipment with corresponding PCI values and scanned signal strength (e.g., RSRP) values.

At act 408, scheduling engine 102 can then filter from the organized an/or ranked of listing neighboring serving cell equipment serving cell equipment that: operate in the same frequency band, and/or are operational in the vicinity of serving cell equipment that is currently serving aerial UE. Neighboring serving cell equipment that are determined to both operate in the same frequency band, and that are operational within a defined or definable vicinity of serving cell equipment that is currently serving aerial UE can be placed in a list of identified neighboring serving cell equipment.

At act 410 scheduling engine 102 can thereafter direct serving cell equipment and/or serving cell equipment identified in the list of identified neighboring serving cell equipment to engage into EICIC. Scheduling engine 102, at act 410, can consider serving cell equipment included in the list of identified neighboring serving cell equipment as being aggressor serving cell equipment and the serving cell equipment as being the victim serving cell equipment (e.g., victim serving cell equipment will typically be serving cell equipment excluded from the list of identified neighboring serving cell equipment).

Scheduling engine 102, at act 412, can then generate an aggregated ABS schedule that serving cell equipment included in the list of identified neighboring serving cell equipment can use in order to overcome forward link interference caused by aerial UE with the object of reducing intra-frequency interference. The aggregated ABS schedule reduces and/or eliminates overall interference caused by aerial UE to serving cell equipment included in the list of identified neighboring serving cell equipment. The aggregated ABS schedule in some embodiments can be generated based on determined interference that each serving cell equipment included in the list of identified neighboring serving cell equipment is injecting into aerial UE and/or UE demand requirements.

FIG. 5 depicts an example time sequence chart 500 that can be used to effectuate and/or facilitate that can be used to dynamically configure inter-cell interference coordination between terrestrial based serving cell equipment that are serving aerial UE with the aim of reducing and/or eliminating the overall interference caused by aerial UE. The described time sequence chart 500 can be used by central node global control equipment located on the core network.

Time sequence chart 500 can commence at act 502 wherein core network equipment (e.g., scheduling engine 102) can collect UE data, UE device type data, serving cell equipment data, network topology data, and/or geographical topographic data. At act 502, in some embodiments, scheduling engine 102 can detect when, where, and whether an aerial UE is attached to and/or is in operative communication with the core network (or identifiable segments of the core network). Additionally, at act 502, scheduling engine 102 can collect data representative of serving cell equipment capabilities, as well as network topologies of serving cell equipment. Further at act 502 scheduling engine 102 can also collect data representative of the geographical topographies and/or locations within which current serving cell equipment and its neighboring serving cell equipment are situated.

At act 504 scheduling engine 102, as a function of data representative of UE information and UE device type, can determine whether or not a UE is an aerial UE. Information in regard to whether or not UE is an aerial type UE or terrestrial based UE can be conveyed and communicated to central node global control equipment (e.g. scheduling engine 102) as flag data comprising one or more bits. Also at act 504, scheduling engine 102 can utilize and/or consult, for example, one or more database equipment comprising groups of relevant database tuples to correlate the received flag data with an UE type (e.g., aerial UE or terrestrial based UE).

Additionally at act 504, scheduling engine 102, as a function of data representative of serving cell equipment capabilities, network topologies of serving cell equipment, and the geographical topographies and/or locations within which serving cell equipment are situated, can determine whether serving cell equipment support EICIC.

At act 506, in instances where serving cell equipment supports EICIC, scheduling engine 102 can collect KPI values returned to, or received by, serving cell equipment (or central node global control equipment) by UE (terrestrial based and/or aerial) located within the coverage ambit of serving cell equipment.

Also at act 506, scheduling engine 102, in some embodiments, can use RSRP value data and SNR value data received from aerial UE to generate a ranked and/or ordered listing of serving cell equipment and determine whether SNR value data is low. Scheduling engine 102 can determine whether or not SNR value data is low, for example, by comparing received SNR value data with one or more defined or definable threshold values. At act 508, in instances where it is determined that SNR value data is low, scheduling engine 102, at act 510, can request UE to scan and report back, at act 512, data pertaining to neighboring serving cell equipment with corresponding PCI values and scanned signal strength (e.g., RSRP) values.

At act 514, scheduling engine 102 can then filter from the organized an/or ranked of listing neighboring serving cell equipment serving cell equipment that: operate in the same frequency band, and/or are operational in the vicinity of serving cell equipment that is currently serving aerial UE. Neighboring serving cell equipment that are determined to both operate in the same frequency band, and that are operational within a defined or definable vicinity of serving cell equipment that is currently serving aerial UE can be placed in a list of identified neighboring serving cell equipment.

At act 516 scheduling engine 102 can thereafter direct serving cell equipment and/or serving cell equipment identified in the list of identified neighboring serving cell equipment to engage into EICIC. Scheduling engine 102, at act 516, can consider serving cell equipment included in the list of identified neighboring serving cell equipment as being aggressor serving cell equipment and the serving cell equipment as being the victim serving cell equipment (e.g., victim serving cell equipment will typically be serving cell equipment excluded from the list of identified neighboring serving cell equipment).

Scheduling engine 102, at act 518, can then generate an aggregated ABS schedule that serving cell equipment included in the list of identified neighboring serving cell equipment can use in order to overcome forward link interference caused by aerial UE with the object of reducing intra-frequency interference. The aggregated ABS schedule reduces and/or eliminates overall interference caused by aerial UE to serving cell equipment included in the list of identified neighboring serving cell equipment. The aggregated ABS schedule in some embodiments can be generated based on determined interference that each serving cell equipment included in the list of identified neighboring serving cell equipment is injecting into aerial UE and/or UE demand requirements.

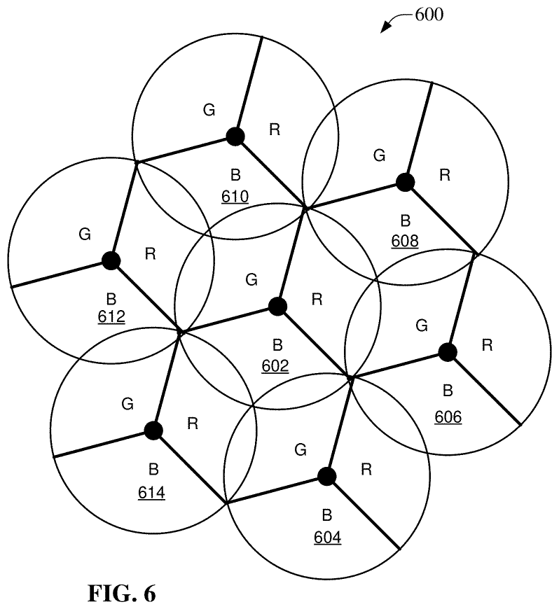

FIG. 6 provides illustration 600 of serving cell equipment 602 and its neighbor cell equipment (e.g., neighbor cell equipment 604, neighbor cell equipment 606, neighbor cell equipment 608, neighbor cell equipment 610, neighbor cell equipment 612, and neighbor cell equipment 614). As will be observed each of serving cell equipment 602, and its neighboring serving cell equipment, can be divided into 120° arc sectors denoted as red (R), green (G), and blue (B). As will be noted with regard to the 120° arc sectors, from the perspective of serving cell equipment 602, at the peripheral edge (e.g., the utmost broadcast extent of the serving cell equipment) of the green (G) sector of serving cell equipment 602 overlaps with the respective peripheral edges of transmission arc sectors cast by neighboring serving cells 610 (e.g., blue (B) arc sector) and 612 (e.g., red (R) arc sector). Similarly, once again from the perspective of serving cell equipment 602, the peripheral edge of the blue (B) sector of serving cell equipment 602 overlaps with the respective peripheral edges of transmission arc sectors cast by neighboring serving cells 614 (e.g., red (R) arc sector) and 604 (e.g., green (G) arc sector). Further, from the perspective of serving cell equipment 602, the peripheral edge of the red (R) sector of serving cell equipment 602 overlaps with the respective peripheral edges of transmission arc sectors cast by neighboring serving cells 606 (e.g., green (R) arc sector) and 608 (e.g., blue (B) arc sector).

In each of these overlapping areas, terrestrial UE in correspondence with serving cell equipment 602 and located in these overlapping regions generally will not be subject to interference to the same extent as aerial UE at height over terrain and situated in these overlapping areas and also in communication with serving cell equipment 602. Aerial UE placed in these situations, rather than detecting signal traffic from serving cell equipment 602 (the serving cell equipment to which it is in communication) may detect signal traffic (in the form of intra-frequency interference) from one or more surrounding serving cell equipment (e.g., neighbor cell equipment 604, neighbor cell equipment 606, neighbor cell equipment 608, neighbor cell equipment 610, neighbor cell equipment 612, and/or neighbor cell equipment 614). Consequently, such intra-frequency interference can result in low throughput, session drops, and/or handover failures.

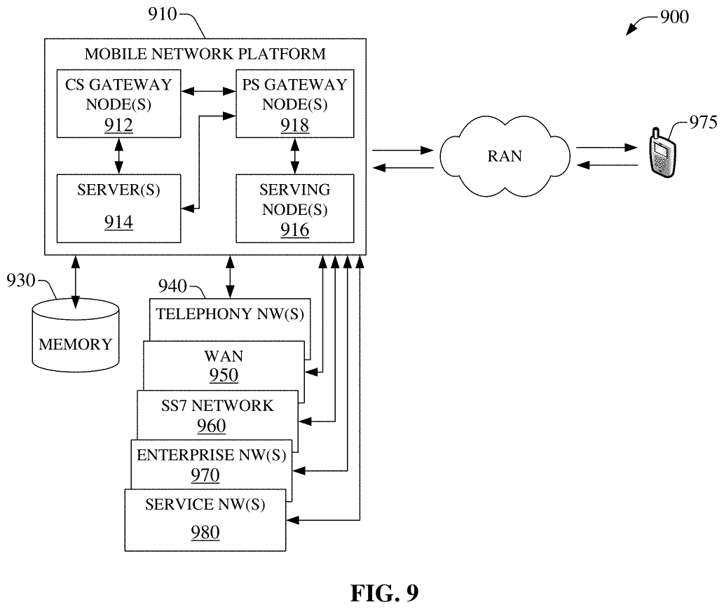

FIG. 9 presents an example embodiment 900 of a mobile network platform 910 that can implement and exploit one or more aspects of the disclosed subject matter described herein. Generally, wireless network platform 910 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 910 can be included in telecommunications carrier networks, and can be considered carrier-side components as discussed elsewhere herein. Mobile network platform 910 includes CS gateway node(s) 912 which can interface CS traffic received from legacy networks like telephony network(s) 940 (e.g., public switched telephone network (PSTN), or public land mobile network (PLMN)) or a signaling system #7 (SS7) network 970. Circuit switched gateway node(s) 912 can authorize and authenticate traffic (e.g., voice) arising from such networks. Additionally, CS gateway node(s) 912 can access mobility, or roaming, data generated through SS7 network 960; for instance, mobility data stored in a visited location register (VLR), which can reside in memory 930. Moreover, CS gateway node(s) 912 interfaces CS-based traffic and signaling and PS gateway node(s) 918. As an example, in a 3GPP UMTS network, CS gateway node(s) 912 can be realized at least in part in gateway GPRS support node(s) (GGSN). It should be appreciated that functionality and specific operation of CS gateway node(s) 912, PS gateway node(s) 918, and serving node(s) 916, is provided and dictated by radio technology(ies) utilized by mobile network platform 910 for telecommunication.

In addition to receiving and processing CS-switched traffic and signaling, PS gateway node(s) 918 can authorize and authenticate PS-based data sessions with served mobile devices. Data sessions can include traffic, or content(s), exchanged with networks external to the wireless network platform 910, like wide area network(s) (WANs) 950, enterprise network(s) 970, and service network(s) 980, which can be embodied in local area network(s) (LANs), can also be interfaced with mobile network platform 910 through PS gateway node(s) 918. It is to be noted that WANs 950 and enterprise network(s) 970 can embody, at least in part, a service network(s) like IP multimedia subsystem (IMS). Based on radio technology layer(s) available in technology resource(s) 917, packet-switched gateway node(s) 918 can generate packet data protocol contexts when a data session is established; other data structures that facilitate routing of packetized data also can be generated. To that end, in an aspect, PS gateway node(s) 918 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 900, wireless network platform 910 also includes serving node(s) 916 that, based upon available radio technology layer(s) within technology resource(s) 917, convey the various packetized flows of data streams received through PS gateway node(s) 918. It is to be noted that for technology resource(s) 917 that rely primarily on CS communication, server node(s) can deliver traffic without reliance on PS gateway node(s) 918; for example, server node(s) can embody at least in part a mobile switching center. As an example, in a 3GPP UMTS network, serving node(s) 916 can be embodied in serving GPRS support node(s) (SGSN).

For radio technologies that exploit packetized communication, server(s) 914 in wireless network platform 910 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 910. Data streams (e.g., content(s) that are part of a voice call or data session) can be conveyed to PS gateway node(s) 918 for authorization/authentication and initiation of a data session, and to serving node(s) 916 for communication thereafter. In addition to application server, server(s) 914 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 910 to ensure network's operation and data integrity in addition to authorization and authentication procedures that CS gateway node(s) 912 and PS gateway node(s) 918 can enact. Moreover, provisioning server(s) can provision services from external network(s) like networks operated by a disparate service provider; for instance, WAN 950 or Global Positioning System (GPS) network(s) (not shown). Provisioning server(s) can also provision coverage through networks associated to wireless network platform 910 (e.g., deployed and operated by the same service provider), such as femto-cell network(s) (not shown) that enhance wireless service coverage within indoor confined spaces and offload radio access network resources in order to enhance subscriber service experience within a home or business environment by way of UE 975.

It is to be noted that server(s) 914 can include one or more processors configured to confer at least in part the functionality of macro network platform 910. To that end, the one or more processor can execute code instructions stored in memory 930, for example. It is should be appreciated that server(s) 914 can include a content manager 915, which operates in substantially the same manner as described hereinbefore.

In example embodiment 900, memory 930 can store information related to operation of wireless network platform 910. Other operational information can include provisioning information of mobile devices served through wireless platform network 910, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 930 can also store information from at least one of telephony network(s) 940, WAN 950, enterprise network(s) 970, or SS7 network 960. In an aspect, memory 930 can be, for example, accessed as part of a data store component or as a remotely connected memory store.

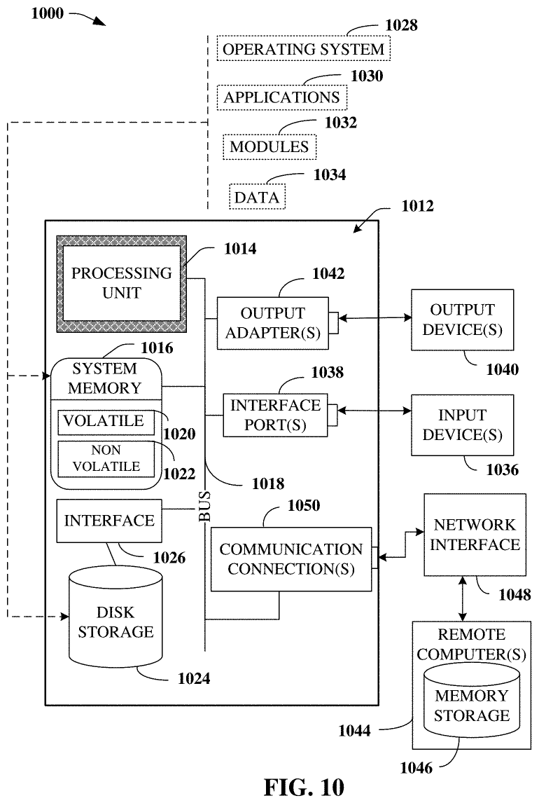

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, part of the hardware of system 100, includes a processing unit 1014, a system memory 1016, and a system bus 1018. System bus 1018 couples system components including, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics, VESA Local Bus (VLB), Peripheral Component Interconnect, Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

System memory 1016 can include volatile memory 1020 and nonvolatile memory 1022. A basic input/output system (BIOS), containing routines to transfer information between elements within computer 1012, such as during start-up, can be stored in nonvolatile memory 1022. By way of illustration, and not limitation, nonvolatile memory 1022 can include ROM, PROM, EPROM, EEPROM, or flash memory. Volatile memory 1020 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 can also include removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to system bus 1018, a removable or non-removable interface is typically used, such as interface 1026.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. For the avoidance of doubt, the term “computer-readable storage device” is used and defined herein to exclude transitory media. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software includes an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. As an example, mobile device and/or portable device can include a user interface embodied in a touch sensitive display panel allowing a user to interact with computer 1012. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 include, for example, a serial port, a parallel port, a game port, a universal serial bus (USB), an infrared port, a Bluetooth port, an IP port, or a logical port associated with a wireless service, etc. Output device(s) 1040 use some of the same type of ports as input device(s) 1036.

Thus, for example, a USB port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 include, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, cloud service, a workstation, a microprocessor based appliance, a peer device, or other common network node and the like, and typically includes many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit-switching networks like Integrated Services Digital Networks (ISDN) and variations thereon, packet switching networks, and Digital Subscriber Lines (DSL). As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media, device readable storage devices, or machine readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) LTE; 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of systems and methods illustrative of the disclosed subject matter. It is, of course, not possible to describe every combination of components or methods herein. One of ordinary skill in the art may recognize that many further combinations and permutations of the disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. Network equipment, comprising:
a processor; and
a memory that stores instructions that, when executed by the processor, facilitates performance of operations, comprising:
receiving, via a user equipment, key performance indicator value data and user equipment device type data;
receiving, via serving cell equipment, serving cell equipment data representing a serving cell equipment capability;
based on the user equipment device type data and the serving cell equipment capability, facilitating the serving cell equipment to implement an enhanced inter-cell interference coordination process; and
generating, based on the serving cell equipment data, an aggregated almost blank subframe schedule for use by the serving cell equipment.

2. The network equipment of claim 1, wherein the operations comprise determining, based on the user equipment type data, that the user equipment is aerial user equipment.

3. The network equipment of claim 1, wherein the operations further comprise receiving, via database equipment, network topology data associated with the serving cell equipment.

4. The network equipment of claim 1, wherein the key performance indicator value data represents signal to noise ratio data, and wherein the operations further comprise determining that the signal to noise ratio data is less than a threshold value.

5. The network equipment of claim 4, wherein the serving cell equipment is associated with a first physical cell identity value, and wherein the operations further comprise facilitating the user equipment to return a report comprising a group of neighbor cell equipment with a second physical cell.

6. The network equipment of claim 4, wherein the key performance indicator values are first key performance indicator values, and the operations further comprise facilitating the user equipment to return second key performance indication values represent a receive signal to receive power value.

7. The network equipment of claim 1, wherein the serving cell equipment operates using a first frequency band, and wherein the operations further comprise generating a listing of neighboring cell equipment that operate in the first frequency band.

8. The network equipment of claim 7, wherein the operations further comprise determining, based on the listing of neighboring cell equipment, a collection of neighboring cell equipment capable of initiating the enhanced inter-cell interference coordination process.

9. A method, comprising:
receiving, by network equipment comprising a processor, key performance indicator value data, user equipment device type data, serving cell equipment data representing a serving cell equipment capability;
based on the user equipment device type data and the serving cell equipment capability, initiating, by the network equipment, an enhanced inter-cell interference coordination process on serving cell equipment; and
based on the serving cell equipment data, generating, by the network equipment, an aggregated almost blank subframe schedule for use by the serving cell equipment.

10. The method of claim 9, further comprises based on the user equipment type data, determining, by the network equipment, that the user equipment is aerial user equipment.

11. The method of claim 9, further comprises receiving, by the network equipment, network topology data associated with the serving cell equipment.

12. The method of claim 9, wherein the key performance indicator value data represents signal to noise ratio data, and wherein the method further comprises determining, by the network equipment, that the signal to noise ratio data is less than a threshold value.

13. The method of claim 12, wherein the serving cell equipment is associated with a first physical cell identity value, and wherein the method further comprises obtaining, by the network equipment, a report comprising a group of neighbor cell equipment with a second physical cell identity.

14. A non-transitory machine-readable medium, comprising executable instructions that, when executed by a processor, facilitate performance of operations, comprising:
receiving key performance indicator value data, user equipment device type data, serving cell equipment data representing a serving cell equipment capability;
based on the user equipment device type data and the serving cell equipment capability, initiating an enhanced inter-cell interference coordination process on serving cell equipment; and
based on the serving cell equipment data, implementing an aggregated almost blank subframe schedule on the serving cell equipment.

15. The non-transitory machine-readable medium of claim 14, wherein the key performance indicator value data represents signal to noise ratio data, and wherein the operations further comprise determining that the signal to noise ratio data is less than a threshold value.

16. The non-transitory machine-readable medium of claim 15, wherein the serving cell equipment is associated with a first physical cell identity value, and wherein the operations further comprise receiving a report comprising a group of neighbor cell equipment with a second physical cell identity.

17. The non-transitory machine-readable medium equipment of claim 14, wherein the serving cell equipment operates using a first frequency band, wherein the operations further comprise generating a listing of neighboring cell equipment that operate in the first frequency band representing a group of aggressor cell equipment, wherein the key performance value data is first key performance value data, and wherein the group of aggressor cell equipment is associated with respective second key performance value data.

18. The non-transitory machine-readable medium equipment of claim 17, wherein the operations further comprise mandating initiation of an enhanced inter-cell interference coordination process on the serving cell equipment and the group of aggressor cell equipment.

19. The non-transitory machine-readable medium equipment of claim 18, wherein initiation of the enhanced inter-cell interference coordination process comprises using coordinated subframe data and power scheduling data associated respectively with serving cell equipment and the group of aggressor cell equipment, and wherein the initiation of the enhanced inter-cell interference coordination process reduces and eliminates intra-frequency interference.

20. The non-transitory machine-readable medium equipment of claim 19, wherein the initiation of the enhanced inter-cell interference coordination process eliminates the intra-frequency interference induced by the group of aggressor cell equipment to aerial user equipment, wherein the aerial user equipment is being served by the serving cell equipment.
